(19) United States
(12) Patent Application Publication
(10) Pub. No.: US 2026/0112005 A1
(43) Pub. Date: Apr. 23, 2026

(54) DIFFUSION-BASED TUNABLE MEDICAL IMAGING RESTORATION WORKFLOW VIA ITERATIVE REFINEMENTS

(71) Applicant: CANON MEDICAL SYSTEMS CORPORATION, Tochigi (JP)

(72) Inventors: Tzu-Cheng LEE, Vernon Hills, IL (US); Xi CHEN, Vernon Hills, IL (US); Liang CAI, Vernon Hills, IL (US)

(73) Assignee: CANON MEDICAL SYSTEMS CORPORATION, Tochigi (JP)

(21) Appl. No.: 18/924,453

(22) Filed: Oct. 23, 2024

(51) Int. Cl. G06T 5/70; G06T 5/20

(52) U.S. Cl. CPC G06T 5/70; G06T 5/20; G06T 2207/20182

(57) ABSTRACT

A method of denoising an input image, the method including obtaining a diffusion-based probabilistic model that was trained, using at least one target image and at least one conditional image, to perform denoising over a number of denoising steps, performing, using the obtained model, a first sequence of T1 denoising sampling steps based on the input image to generate a first output image that is a first restored image corresponding to the input image, wherein each denoising sampling step of the first sequence of T1 denoising sampling steps includes generating a first seed image according to a first seed image equation, and performing, using the obtained model, a second sequence of T2 denoising sampling steps based on an intermediate image generated as a result of the first sequence of T1 denoising sampling steps to generate a second output image that is a second restored image corresponding to the input image.

### BACKGROUND

### Field

The present disclosure relates to restoration of images.

### Description of the Related Art

Deep learning-based models for image restoration typically use a series of steps to modify an input image to a desired degree. Desired properties of a restored image can vary based on a number of controllable and uncontrollable factors. The image restoration process utilized by a deep-learning model can affect the properties of a restored image.

The foregoing “Background” description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present disclosure.

### SUMMARY

The foregoing paragraphs have been provided by way of general introduction, and are not intended to limit the scope of the following claims. The described embodiments, together with further advantages, will be best understood by reference to the following detailed description taken in conjunction with the accompanying drawings.

In one embodiment, the present disclosure is related to a method of denoising an input image, the method comprising obtaining a diffusion-based probabilistic model that was trained, using at least one target image and at least one conditional image, to perform denoising over a number of denoising steps; performing, using the obtained model and a first seed image, a first sequence of T1 denoising sampling steps based on the input image to generate a first output image that is a first restored image corresponding to the input image, wherein each denoising sampling step of the first sequence of T1 denoising sampling steps includes generating the first seed image according to a first seed image function; and performing, using the obtained model and a second seed image, a second sequence of T2 denoising sampling steps based on an intermediate image generated as a result of the first sequence of T1 denoising sampling steps to generate a second output image that is a second restored image corresponding to the input image, wherein each denoising sampling step of the second sequence of T2 denoising sampling steps includes generating the second seed image according to a second seed image function.

In one embodiment, the present disclosure is related to a non-transitory computer-readable storage medium for storing computer readable instructions that, when executed by a computer, cause the computer to perform a method, the method comprising obtaining a diffusion-based probabilistic model that was trained, using at least one target image and at least one conditional image, to perform denoising over a number of denoising steps; performing, using the obtained model and a first seed image, a first sequence of T1 denoising sampling steps based on the input image to generate a first output image that is a first restored image corresponding to the input image, wherein each denoising sampling step of the first sequence of T1 denoising sampling steps includes generating the first seed image according to a first seed image function; and performing, using the obtained model and a second seed image, a second sequence of T2 denoising sampling steps based on an intermediate image generated as a result of the first sequence of T1 denoising sampling steps to generate a second output image that is a second restored image corresponding to the input image, wherein each denoising sampling step of the second sequence of T2 denoising sampling steps includes generating the second seed image according to a second seed image function.

In one embodiment, the present disclosure is related to an apparatus, comprising processing circuitry configured to obtain a diffusion-based probabilistic model that was trained, using at least one target image and at least one conditional image, to perform denoising over a number of denoising steps; perform, using the obtained model and a first seed image, a first sequence of T1 denoising sampling steps based on the input image to generate a first output image that is a first restored image corresponding to the input image, wherein each denoising sampling step of the first sequence of T1 denoising sampling steps includes generating the first seed image according to a first seed image function; and perform, using the obtained model and a second seed image, a second sequence of T2 denoising sampling steps based on an intermediate image generated as a result of the first sequence of T1 denoising sampling steps to generate a second output image that is a second restored image corresponding to the input image, wherein each denoising sampling step of the second sequence of T2 denoising sampling steps includes generating the second seed image according to a second seed image function.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a series of denoised images according to one embodiment of the present disclosure;

FIG. 2A is a denoised image according to one embodiment of the present disclosure;

FIG. 2B is a denoised image using a scaling seed image function according to one embodiment of the present disclosure;

FIG. 2C is a denoised image using a low-pass filter seed image function according to one embodiment of the present disclosure;

FIG. 3A is a denoised image using a scaling seed image function according to one embodiment of the present disclosure;

FIG. 3B is a denoised image using a scaling seed image function according to one embodiment of the present disclosure;

FIG. 3C is a denoised image using a scaling seed image function according to one embodiment of the present disclosure;

FIG. 4A is a denoised image using a low-pass filter seed image function according to one embodiment of the present disclosure;

FIG. 4B is a denoised image using a low-pass filter seed image function according to one embodiment of the present disclosure;

FIG. 4C is a denoised image using a low-pass filter seed image function according to one embodiment of the present disclosure;

FIG. 5 is a workflow of image denoising according to one embodiment of the present disclosure;

FIG. 6 is a workflow of image denoising according to one embodiment of the present disclosure;

FIG. 7 is a method of image denoising according to one embodiment of the present disclosure;

FIG. 8 is a schematic of a hardware system for performing a method according to one embodiment of the present disclosure; and

FIG. 9 is a schematic of an imaging system according to one embodiment of the present disclosure.

### DETAILED DESCRIPTION

Referring now to the drawings, wherein like reference numerals designate identical or corresponding parts throughout the several views.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

In one embodiment, the present disclosure is directed to systems and methods for image restoration using deep learning-based models. Image restoration techniques can include, but are not limited to, denoising, deblurring, resolution enhancement (e.g., super-resolution imaging), and image/signal reconstruction (e.g., compressed sensing). Each of these techniques can be used independently or in combination to improve the visibility of features in an image. Image restoration has important applications for medical imaging modalities such as computed topography (CT) scanning, magnetic resonance imaging (MRI), etc., which are often subject to noise due to physical interactions within the imaging systems. It can be appreciated that the systems and methods described herein are not limited to medical imaging applications and can be used for various imaging types and techniques. In particular, the methods of the present disclosure can be useful for processing any volumes of image data (e.g., a series of images or image slices) that are acquired over a spatial or temporal span.

Generative deep learning-based models can be used to degrade noise and similar artifacts in an acquired image in order to generate a restored image that is of higher quality than the acquired image. In one embodiment, a generative model can be used to denoise an image by converting a first data distribution (noisy image data) to a second data distribution (restored image data). In one embodiment, the generative model can be a denoising diffusion probabilistic model (DDPM). It can be appreciated that DDPMs are described herein as an illustrative example of a class of generative models, and that other types of probabilistic models and especially diffusion-based probabilistic models for image restoration are also compatible with the methods of the present disclosure.

A DDPM can be used to denoise an image in a series of diffusion steps. The DDPM can be trained to denoise an image in an iterative process, wherein the DDPM generates an increasingly denoised image at each diffusion step. The DDPM can be trained to denoise an image by converting a first probability distribution corresponding to an input image (e.g., a noisy image) to a predicted second probability distribution corresponding to an output image (e.g., a denoised image). In one example, the first probability distribution can be a normal distribution corresponding to normal (Gaussian) noise that is present in an acquired image. The DDPM can be trained to remove the noise by converting the normal probability distribution to a predicted distribution corresponding to a denoised, restored image.

In one embodiment, a DDPM can be trained using a set or sequence of training images. The set of training images can include a target image, which is a clean or denoised image, and noisy images that are generated from the target image. In one embodiment, the noisy training images can be generated by applying modeled noise (e.g., Gaussian noise) to the target image in one or more steps. The set of training images can include images with increasing amounts of noise. The set of training images can further include a pure noise image generated from the target image. In one embodiment, the modeled noise can be similar to or based on an expected type of noise in an acquired image that the DDPM will be used to restore. In one embodiment, the target image can be similar to or based on a type of image that the DDPM will be used to recover. The training images can each be input to the DDPM. The DDPM can be trained to denoise an input training image to output a restored image at each step in a series of diffusion steps. The series of diffusion steps can correspond to the one or more steps used to apply noise to the target image. In this manner, the DDPM can be trained to “reverse” a stepwise process for applying noise to an image in order to remove said noise from the image.

At each diffusion step, the DDPM can be trained to minimize a loss function, the loss function corresponding to a difference in noise between a predicted output image and a training image for the given diffusion step. The DDPM can therefore be trained to accurately predict and model a difference in noise between each input image and an output image at each diffusion step. In one embodiment, the training of the DDPM can include setting one or more weights of the model. The one or more weights of the model can vary for each diffusion step within the series of diffusion steps or for at least one of the diffusion steps within the series. In one embodiment, a conditional image can be input to the DDPM during the training process to guide the generation of output images. In one embodiment, the conditional image can be the target image. The target image used for training the DDPM can be at least one target image and can include more than one target image. For example, the at least one target image can include a low-resolution medical image (e.g., CT image) and an edge-detected medical image (e.g., CT image) or otherwise processed medical image. Similarly, the conditional image used for training the DDPM can be at least one conditional image and can include more than one conditional image. In one example, the at least one conditional image can include a low-resolution medical image (e.g., CT image) and an edge-detected medical image (e.g., CT image), or otherwise processed medical image. In one example, the at least one conditional image or the at least one target image can include three consecutive conditional images for a multi-dimensional (e.g., 2.5 dimensional) process.

In one embodiment, the input to a trained DDPM can be a noisy image, a conditional image, and a diffusion step (also referred to as a time step or sampling step). The DDPM can predict the second probability distribution corresponding to a restored image given the conditional image as a known condition. In one embodiment, the DDPM can denoise a pure noise image in a series of diffusion steps in order to generate a final restored image. The pure noise image can be the first image input to the DDPM. The DDPM can output a denoised image (also referred to herein as a restored image) for each diffusion step. The denoised image output from each diffusion step in the series can be input to a following diffusion step in order to iteratively denoise the pure noise image. The DDPM can include one or more learned weights used to output the restored image, wherein the value of the one or more learned weights can be dependent on the diffusion step. Additional details regarding the training and use of a DDPM for can be found in Ho, J. et. al, (2020). “Denoising diffusion probabilistic models.” Advances in neural information processing systems, 33, 6840-6851 and in Xia, W. et. al, (2022). “Low-Dose CT Using Denoising Diffusion Probabilistic Model for 20× times Speedup.” arXiv preprint arXiv:2209.15136, each of which is incorporated herein by reference in its entirety for all purposes.

Images that are restored using deep-learning models can vary in quality (e.g., noise, resolution, image texture, contrast enhancement) and other image properties. These variations can result from differences in the acquisition protocol and quality of an initial noisy input image, pre-restoration processing, post-restoration processing, and the denoising model itself (e.g., model architecture, model training). The properties of a restored image can be unpredictable, as the relationship between properties of the input image and properties of the restored image can be complex and not easily modeled. In addition, it can be desired for a restored image to have certain image properties depending on the context in which the restored image is used. For example, certain medical image analyses can require high-resolution images with reduced noise, while other medical image analyses require high-fidelity images with minimal smoothing. It can be difficult to build and train a single DDPM to restore images from varying inputs and according to diverse quality parameters and requirements.

As a result, there is a need to tune parameters of a DDPM during image restoration in order to generate a restored image having desired image properties. A tunable DDPM can have broader functionality and can be used to restore input images of varying quality with predictable results. In one embodiment, a tunable DDPM, as described herein, can be trained using a single training set in a manner similar to the training of a non-tunable DDPM. The tunable DDPM can therefore be used for improved performance without increasing the complexity of training or fit of the model.

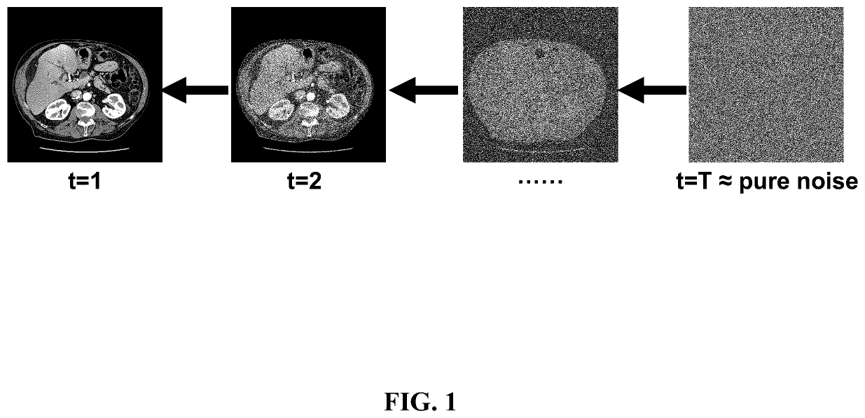

FIG. 1 illustrates a denoising process using a trained DDPM according to one embodiment of the present disclosure. A pure noise image x_{T} at t=T can be input to the DDPM. The pure noise image x_{T} can be generated using a probability distribution model, such as a Gaussian distribution. A conditional image can also be input to the DDPM for the denoising process. In one embodiment, the conditional image can be an acquired image (e.g., a medical image) that is being denoised. The conditional image can include more than one conditional images, such as an edge-detected image or otherwise processed image.

The DDPM can denoise the pure noise image x_{T} in a series of T diffusion steps (e.g., from t=T to t=1) to generate a sequence of restored images x_{T-1}, x_{T-2}, etc. At each diffusion step, the restored image from the previous diffusion step can be input to the DDPM along with the conditional image and the timestep (t=T−1, t=T−2, etc.). For example, the DDPM can denoise the pure noise image x_{T} based on conditional image Y to generate the restored image x_{T-1} at time step T−1. The DDPM can then denoise the image x_{T-1} based on the conditional image C to generate a further restored image x_{T-2} at time step T−2. At time step t=1, the DDPM can output an image x₀ that is a denoised version of the conditional image Y.

In one embodiment, the DDPM can generate a restored image in each diffusion step using Equation 1:

$${x}_{t - 1} = \frac{1}{\sqrt{{α}_{t}}} ( {x}_{t} - \frac{1 - {α}_{t}}{\sqrt{1 - {\overline{α}}_{t}}} {ϵ}_{θ} ( {x}_{t} , Y , t ) ) + {σ}_{t} z \qquad Equation 1$$

wherein xₜ is an input image (e.g., a pure noise image at t=T), xₜ₋₁ is a denoised image output, αₜ, α̅ₜ, σₜ are scheduled (time step-dependent) parameters for noise, ϵ_{θ} represents the trained model that receives the input image and the timestep as an input, Y is the conditional image, t is the time step, and z is a parameter following a normal distribution. For example, z can be a Gaussian noise image that follows a unit normal distribution [symbol] (0,1).

In one embodiment, a DDPM can be tuned by adjusting the noise term σₜz that is added to a denoised image. In one embodiment, the noise can be an image generated using a piecewise function. More specifically, a noise image z can be input to one or more modifying functions to generate a modified noise image. In one embodiment, the noise image g(z) can be referred to as a seed image or seed noise. The function used to generate the seed image can be referred to as a seed image function or equation. The modifying functions and the time intervals at which the modifying functions are applied can be set and adjusted to tune the DDPM. In one embodiment, a tunable DDPM can generate a restored image in each diffusion step using Equation 2:

$${x}_{t - 1} = \frac{1}{\sqrt{{α}_{t}}} ( {x}_{t} - \frac{1 - {α}_{t}}{\sqrt{1 - {\overline{α}}_{t}}} {ϵ}_{θ} ( {x}_{t} , Y , t ) ) + \{ \begin{matrix}{σ}_{t} z , t \geq {t}^{′} \\ {σ}_{t} g ( z ) , t < {t}^{′}\end{matrix} \qquad Equation 2$$

During the initial t′ time steps, the noise image z can be a Gaussian noise image that follows a unit normal distribution z˜ [symbol] (0,1), and the multiplicative noise parameter σₜ can be dependent on the time step t. After the t′steps, the unit Gaussian noise image z˜ [symbol] (0,1) can be input to the modifying function g to generate a modified noise image g(z), which can be multiplied by the time step-dependent noise parameter σₜ to generate a noise term.

In one embodiment, the function g can be a linear function. In one embodiment, the function g can multiply an input (e.g., z) by a value in order to scale the input. For example, g(z)=ƒz, wherein ƒ is a constant. The modified noise image g(z) can therefore be a scaled Gaussian noise image when the input z is the unit Gaussian noise image. The linear function can scale image values (e.g., intensity values) of the noise image to create a wider range of values. In one embodiment, ƒ can be a time step-dependent constant or variable. In one embodiment, the function g can be a non-linear function.

In one embodiment, the function g can be a filter. The filter can include, but is not limited to, a low-pass filter, a high-pass filter, a bandpass filter, a notch filter, etc. In one embodiment, the filter can be an averaging filter. In one embodiment, the filter can be a kernel that is convolved with the image z. In one embodiment, the filter (e.g., a low-pass filter, a Gaussian filter) can be applied to the noise image z to reduce noise in the image. The modified noise image can then be multiplied by the time step-dependent noise parameter σₜ.

In one embodiment, the function g can be selected according to a desired quality or property of the restored image. For example, a scaling function g(z)=ƒz can be used to generate a restored image with higher resolution, e.g., more detail. The scaled noise image can provide a wider range of noise values that are used to restore the image. A high-resolution restored image can be useful for assessing details and small features in the restored image. In one embodiment, a high-resolution restored image can be used to assess changes in an imaged region over time. In another example, a low-pass filter can be used to smooth and reduce noise in a restored image. A smoothed restored image can be useful for assessing larger features, such as anatomical structures, in the restored image.

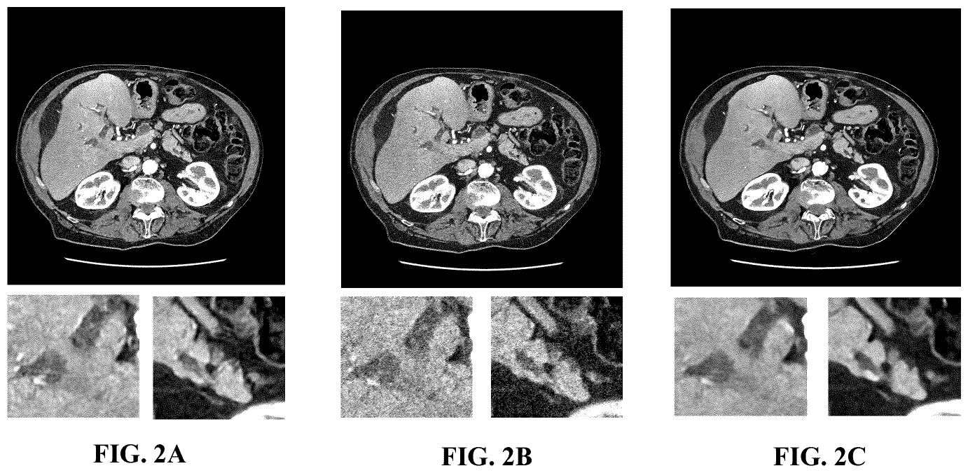

FIG. 2A through FIG. 2C are examples of restored images generated by a DDPM using different functions g(z) in Equation 2 according to one embodiment. FIG. 2A is a restored image when g(z)=z. Close-up details of the restored image are also illustrated in FIG. 2A. In this case, the noise image z is a unit Gaussian noise image that is multiplied by the time step-dependent noise parameter σₜ. In one embodiment, the DDPM can be trained using 2000 time steps and can generate the restored image in 200 time steps.

FIG. 2B is a restored image when g(z)=1.1z. Close-up details of the restored image are also illustrated in FIG. 2B. The unit Gaussian noise image z can be scaled by the constant value 1.1. The application of the constant multiplier to the image z can result in a more detailed restored image. The restored image of FIG. 2B can have a higher resolution than the restored image of FIG. 2A. In one embodiment, the DDPM can be trained using 2000 time steps and can generate the restored image in 200 time steps. In one embodiment, the modifying function g(z)=1.1z can be applied when t<17 to generate FIG. 2B.

FIG. 2C is a restored image when g(z) is a low-pass filter. Close-up details of the restored image are also illustrated in FIG. 2C. The application of the low-pass filter to the image z can result in a smoother restored image. The restored image of FIG. 2C can be smoother than the restored image of FIG. 2A and the restored image of FIG. 2B. The details of the restored image FIG. 2C can be smoothed out. In one embodiment, the DDPM can be trained using 2000 time steps and can generate the restored image in 200 time steps. In one embodiment, the modifying function g(z) can be applied when t<16 to generate FIG. 2C.

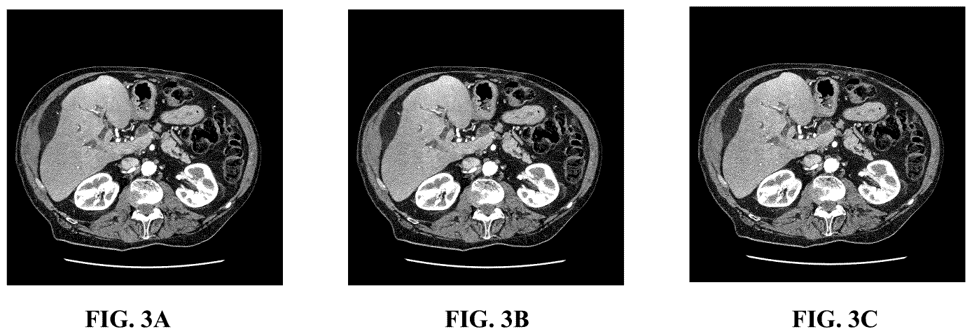

FIG. 3A through FIG. 3C are examples of restored images generated by a DDPM using the modifying functions g(z)=ƒz in Equation 2 according to one embodiment. The DDPM can be trained using 2000 time steps and can generate the restored image in 200 time steps. The value of the constant multiplier ƒ can vary for each of FIG. 3A through FIG. 3C. In one embodiment, the modifying function g(z)=ƒz can be applied when t<15 to generate FIG. 3A through FIG. 3C. The modifying function used to generate the restored image of FIG. 3A can be g(z)=1.01z. The modifying function used to generate the restored image of FIG. 3B can be g(z)=1.05z. The modifying function used to generate the restored image of FIG. 3C can be g(z)=1.1z. Increasing the value of the multiplier ƒ can result in more visible detail in the restored image but can also result in more noise in the image. The value of ƒ can be set according to a desired image resolution and tolerance for noise.

In one embodiment, the time step t′ at which the function g is applied to the noise image z can be tuned. Modifying the time step t′ can modulate the effect of the function g on the denoising process. For example, a larger t′ value can result in the function g being applied to the noise image z earlier, while a smaller t′ value can result in the function g being applied to the noise image z later. Earlier application of the function g can result in the effect of the function (increasing resolution, smoothing, etc.) being more pronounced in the denoised image. In one embodiment, the function g can be applied as an initial condition, e.g., at t′=T.

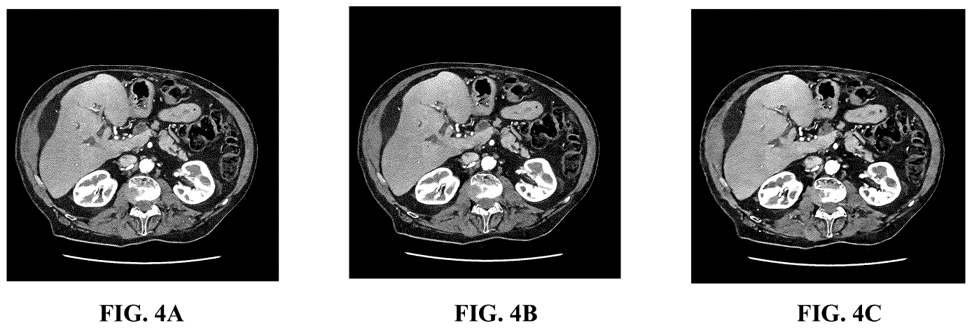

Tuning the modifying function g(z) and the time interval(s) at which the modifying function is applied can have different results on the output of the DDPM. FIG. 4A through FIG. 4C are examples of output images of the DDPM when the modifying function g(z) is a low-pass filter applied at varying time intervals according to Equation 2. The low-pass filter can be a Gaussian filter (kernel) having a standard deviation of 7. In one embodiment, a DDPM can be trained using 2000 timesteps and can be used to restore an image in 200 timesteps.

FIG. 4A is an example of a restored image when t′=15. FIG. 4B is an example of a restored image when t′=16. FIG. 4C is an example of a restored image when t′=17. The earlier application of the modifying function (at greater t′ values) results in a more pronounced smoothing effect in the restored image. Changing the time interval by a single time step can result in a clear difference in the restored image, as illustrated in FIG. 4A through FIG. 4C. The time t′ at which the modifying function is applied can be set based on a desired degree of image smoothing and detail.

In one embodiment, Equation 2 can be further modified to include more than one modifying function (e.g., g₁(z), g₂(z), etc.). In one embodiment, the functions can have the same form. For example, g₁(z) and g₂(z) can both be linear functions such that g₁(z)=ƒ₁z, g₂(z)=ƒ₂z, where ƒ₁ and ƒ₂ are constants. In one embodiment, the functions can have different forms. For example, a first function g₁(z) can be a low-pass filter, while a second function g₂(z) can be a sampling function. In one embodiment, each function can be applied for a time interval. For example, the functions can be applied as follows in Equation 3:

$${\overline{x}}_{t - 1} = \frac{1}{\sqrt{{α}_{t}}} ( {\overline{x}}_{t} - \frac{1 - {α}_{t}}{\sqrt{1 - {\overline{α}}_{t}}} {ϵ}_{θ} ( {\overline{x}}_{t} , Y , t ) ) + \{ \begin{matrix}{σ}_{t} z , t \geq {t}^{′} \\ {σ}_{t} {g}_{1} ( z ) , {t}^{″} \leq t < {t}^{′} \\ {σ}_{t} {g}_{2} ( z ) , t < {t}^{″}\end{matrix} \qquad Equation 3$$

In one embodiment, one or more modifying functions can be applied for an intervening time interval. For example, the DDPM can generate a restored image according to Equation 4:

$${\overline{x}}_{t - 1} = \frac{1}{\sqrt{{α}_{t}}} ( {\overline{x}}_{t} - \frac{1 - {α}_{t}}{\sqrt{1 - {\overline{α}}_{t}}} {ϵ}_{θ} ( {\overline{x}}_{t} , Y , t ) ) + \{ \begin{matrix}{σ}_{t} z , t \geq {t}^{′} \\ {σ}_{t} g ( z ) , {t}^{″} \leq t < {t}^{′} \\ {σ}_{t} z , t < {t}^{″}\end{matrix} \qquad Equation 4$$

It can be appreciated that any number and combination of operations can be implemented in the piecewise function at any number and length of time intervals.

The DDPM be tuned by modifying the function g(z) and the piecewise function applying g(z) to generate a noise term. A single DDPM can therefore be used to generate different restored images from an input image. The restored images can have different properties as a result of the function g(z) that is used to generate the noise image. In one embodiment, a DDPM as described herein can be used in an iterative restoration process. For example, the DDPM can be used to generate a first restored image based on an input image in a first iteration. The piecewise function can be modified and the DDPM can be used to generate a second restored image based on the input image in a second iteration.

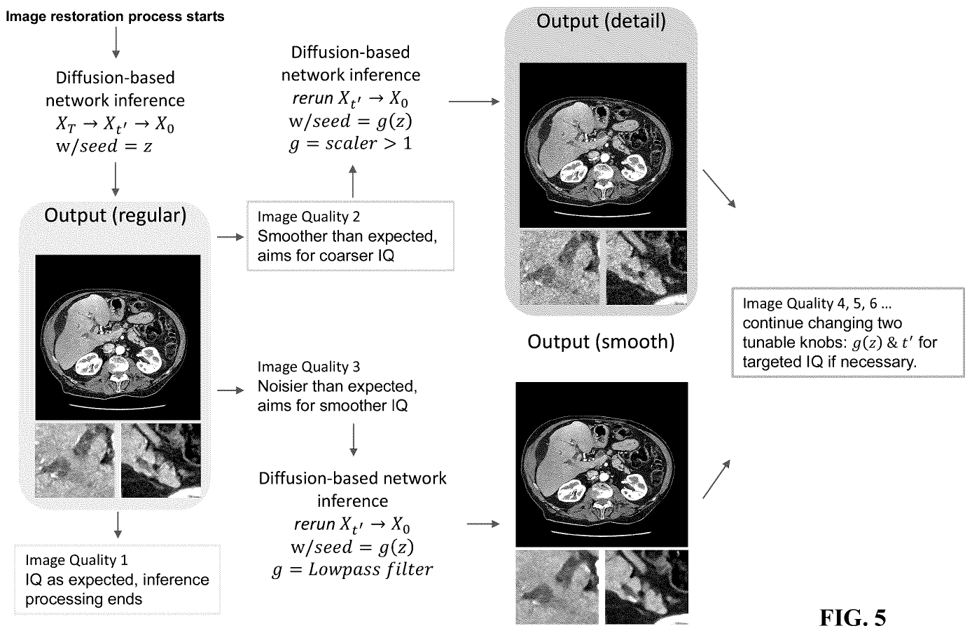

FIG. 5 illustrates an iterative workflow of image restoration according to one embodiment of the present disclosure. The DDPM can generate restored images according to Equation 2. In a first iteration, the noise image z used for restoration can be a Gaussian noise image following a unit normal distribution [symbol] (0,1). In other words, the modifying function can be defined as g(z)=z. The noise image z is therefore generated using the same function and distribution from t=T to t=t′ and from t=t′ to t=0. The DDPM can generate a first restored image.

The first restored image can have a certain degree of noise (e.g., signal-to-noise ratio (SNR)) and a certain image resolution. The degree of noise and the image resolution may be suitable for certain purposes (e.g., certain image analysis processes). For other purposes, a different degree of noise and/or image resolution may be desired. The DDPM can be tuned to denoise the same input image in a second iteration in order to generate a second restored image. For example, the modifying function g(z) can be modified such that g(z)=ƒz, where ƒ>1. A scaling function can increase the resolution of an image such that a second restored image includes more detail than the first restored image. In one example, the modifying function g(z) can be tuned such that g(z) is a low-pass filter. A low-pass filter can smooth an image such that a third restored image has less noise than the first restored image. The parameters of the modifying function g(z) and time intervals at which the modifying function is applied can be further modified for further iterations.

In one embodiment, the modifying function g(z) is applied when t<t′, as presented in Equation 2. In this case, modifying the function g(z) only affects the diffusion steps when t<t′. The diffusion steps when t≥t′ are the same regardless of the modifying function. Therefore, when t′ is constant, it is possible to only repeat the diffusion steps of t<t′ in order to generate different restored images using different modifying functions g(z). For example, an input image can be denoised for T−t′ steps using the noise term σₜz to generate an intermediate denoised image, wherein Tis a total number of steps. At t=t′, a first modifying function g₁(z) can be applied for the remaining t′ time steps to generate the restored image. When a different restored image is desired, the same intermediate denoised image generated from the T−t′ steps in the first denoising process can be input to the DDPM using a different modifying function (e.g., g₂(z)) for t′ time steps. The DDPM can then generate a second (third, etc.) restored image in t′ steps rather than T steps. Generally, an intermediate denoised image that is output after a first time interval corresponding to a first denoising function can be used as an input image of a second denoising function. This approach can reduce the amount of time and processing power needed to generate each restored image.

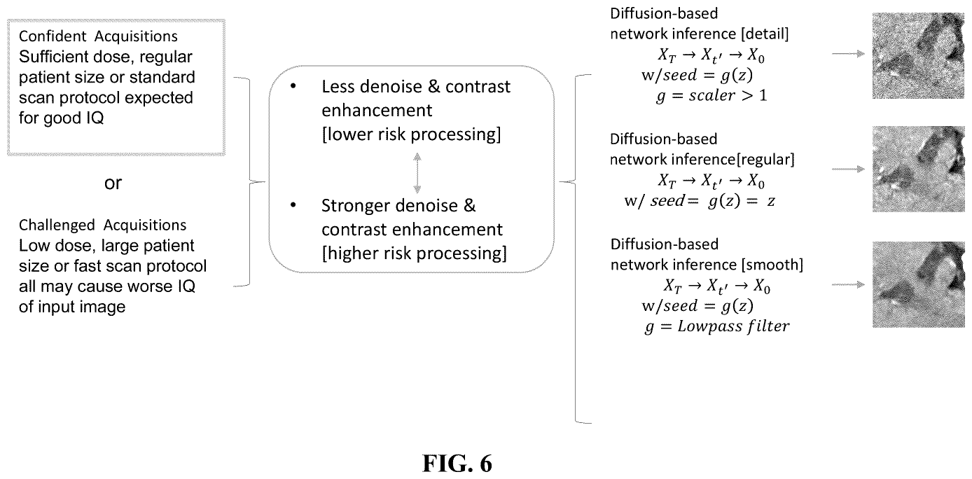

FIG. 6 is an illustration of a workflow for tunable restoration according to one embodiment of the present disclosure. Input images of a sample (e.g., a medical image) to the DDPM can vary in sample characteristics, image quality, acquisition protocol, etc. In one embodiment, a DDPM can be tuned for a type of image restoration based on properties of an input image. For example, enhancing the contrast of a low-quality input image can result in a noisy output image that is not suitable for analysis. The parameters of the DDPM (e.g., the modifying function g(z) and the time interval defined by t′) can be adjusted according to the input image. The parameters can include, but are not limited to, a level or degree of denoising, a resolution, a level or degree of contrast enhancement, etc. In one embodiment, less denoising and less contrast enhancement can be referred to as a “low risk” restoration process because there will likely be less inference and feature loss in the output image. Stronger denoising and contrast enhancement can be referred to as a “high risk” restoration process because there may be feature loss as a result of smoothing and/or inference applied to generate the output image (e.g., by a low-pass filter).

In one embodiment, a property of an output image can be associated with a tuning parameter of the DDPM. In one embodiment, the systems described herein can include a user interface configured to receive an input. For example, a computer (server, etc.) that executes the restoration process using the DDPM can receive input data indicating a desired property of an output image or of the restoration process. The property can include, but is not limited to, an image quality, a degree or level of noise, a contrast level, a range of image values (e.g., pixel values), a resolution, a minimum feature size, a difference between an input image and an output image, etc. In one example, the user interface can receive a selection of image quality. Additionally or alternatively, the user interface can receive input data indicating a property of an input image, as described with reference to FIG. 6. The properties of the input image, the output image, and/or the restoration process can be used to determine a tunable parameter of the image restoration process, such as a modifying function g(z) or a time interval defined by t′. In one example, a modifying function can be defined as g(z)=ƒz based on the input data received by the computer. The value of the constant ƒ can be set based on the input data received by the computer, e.g., a desired degree of contrast enhancement in the output image. In one example, a modifying function g(z) can be defined as a low-pass filter based on the input data received by the computer. The cutoff frequency of the low-pass filter can be set based on the input data received by the computer, e.g., a desired image resolution or minimum feature size. Combinations of modifying functions and corresponding time intervals can also be determined based on the input data.

In one embodiment, the DDPM can be used to selectively restore a region of an input image. For example, a first region of an input image can include small features while a second region of the input image can include larger structures. The DDPM can denoise the first region of the input image using a first modifying function g₁(z) that enhances the contrast and detail of the first region. The DDPM can denoise the second region of the input image using a second modifying function g₂(z) that smooths the second region. In one embodiment, the first modifying function g₁(z) and the second modifying function g₂(z) are not both applied to the entire input image. Rather, the first modifying function g₁(z) can be used only to denoise the first region, and the second modifying function g₂(z) can be used only to denoise the second region. In one embodiment, the regions can be defined by pixels or coordinate locations of the input image. For example, the locations of the regions and a corresponding image restoration property can be input to the DDPM in order to set the modifying functions and/or corresponding time intervals.

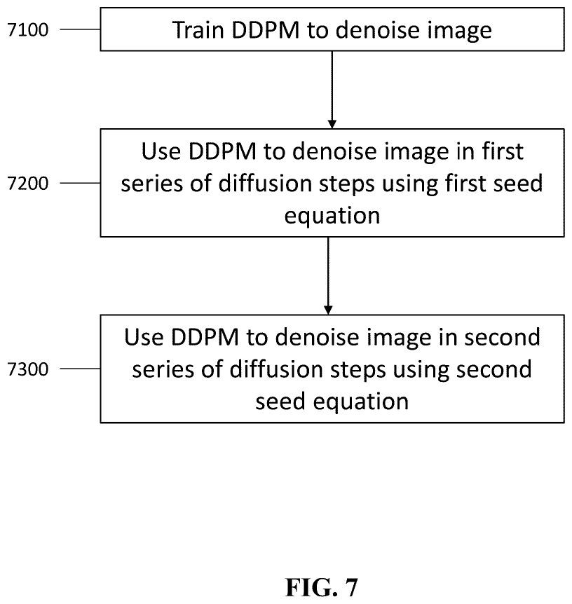

FIG. 7 is a method of denoising an image using a DDPM according to one embodiment of the present disclosure. In step 7100, the DDPM can be trained to denoise an image in a series of iterative diffusion-based steps. In step 7200, the DDPM can be used to denoise an input image in a first series of T diffusion steps. An input image (e.g., a medical image) can be a conditional image for the first series of T diffusion steps. In one embodiment, the denoising steps can utilize Equation 2, wherein the seed image function can be g(z)=z for t<t′. In other words, the seed noise image used for the first series of diffusion steps can be z for the entire series of T diffusion steps. The noise image z can be a unit Gaussian noise image. The DDPM can generate an intermediate denoised image after each diffusion step. The DDPM can output a first output image after the first series of T diffusion steps.

In one embodiment, the first output image can have certain image properties, e.g., a resolution, an image resolution. It can be desired that a restored image has different image properties than the first output image. In this case, the seed image function of the DDPM can be tuned to generate a second output image having the desired image properties. A second seed image function can be, for example, g(z)=ƒz. In step 7300, the DDPM can be used to denoise an image using the second seed image function in a second series of diffusion steps to generate a second output image. The second series of diffusion steps can include t′ steps rather than T steps, wherein t′<T. In one embodiment, the conditional image used for the second series of diffusion steps can be an intermediate denoised image that is generated after T−t′ steps of the first series of diffusion steps. In this manner, the DDPM is only used to repeat t′ steps rather than the total T steps of step 7200. The second output image that is generated after the t′ steps using the second seed image function can have the desired image properties different from the first output image.

In one embodiment, the methods of the present disclosure can be used for bulk diffusion methods of image denoising that take advantage of similarities between adjacent images in a series of images to achieve faster denoising of the series of images using a diffusion-based probability model. The methods described herein can reduce the number of diffusion steps needed to denoise a series of images while retaining inference accuracy. Reducing the number of diffusion steps can result in faster denoising as well as reduced computational power usage.

In one embodiment, the DDPM can be used to denoise a series of images. The series of images can be acquired in sequence over time or over a spatial dimension. For example, a series of images can be acquired over time via a renal scan in order to evaluate kidney function. In the denoising process (also referred to as an inference process or sampling process), the DDPM can denoise and identify larger or more generalized features in initial denoising (diffusion) steps. These larger features are typically consistent throughout a series of images. For example, the general shape and location of the kidney and structures therein can first be identified in a scan image and are not likely to change within a single renal scan. The DDPM can then denoise and identify smaller features or details in later diffusion steps. In the example of a renal scan, the DDPM can identify finer details of the shape and size of renal structures, as well as the location of any contrast dye within the kidney. These details can change throughout the series of images as the renal system processes fluid in the body. Changes throughout the series of images are likely to be gradual and continuous over time. Therefore, adjacent images in a series of images can be similar to each other.

In another example, a series of images can be acquired through a scan of one or more sections of the body along one or more directions. In a similar manner, the DDPM can first denoise and identify larger features such as the general shape of the section of the body and organs therein. The DDPM can then denoise and identify smaller features and/or finer details of the organs. Adjacent images within the series depict portions of the body that are also in close proximity with each other. Therefore, the adjacent images in the series are also likely to be similar to each other and share large features as the scan progresses along the body.

In one embodiment, the method can include grouping images in a series of images and performing initial batch denoising on groups of images using a trained DDPM. A group of images can be a subset of adjacent images within a series of images that are collected over a period of time or over a spatial direction. The series of images can be divided into one or more groups, wherein each group can include one or more images. Each of the one or more groups of images can have the same or a different number of images. For example, a first group of images G₀ can include the first n images in a series, a second group of images G₁ can include the subsequent n+1 to n+m images in a series, etc. The number of images in a group can be referred to herein as a thickness of the group. In one embodiment, the thickness of a group can be modulated based on a type of image acquisition or an object that is being imaged in the series of images. For example, the number of images in a group can be set such that one or more features or a type of feature (e.g., features of a certain size) are constant in each image of the group. In one embodiment, the initial batch denoising can utilize a first modifying function g(z) to denoise the group of images in a series of diffusion steps. Subsequent denoising steps can utilize the same or different modifying functions for refinement of the restored image.

Advantageously, the denoising methods described herein can be used to gradually change the restored image quality of medical imaging by tuning the denoising process in real time (e.g., while the image is being denoised) rather than during the training process or as post-processing. A modifying function can be applied for any time interval during denoising to adjust image quality. The method does not require re-training of a model. The method also does not require dedicated model architecture or training directed to targeting a certain image quality or property. A single DDPM, as described herein, can be easily modified to tune the denoising process and restore an image according to desired parameters.

In one embodiment, the denoising methods can be combined with other tunable machine-learning based image restoration methods. For example, pre-processing can be applied to an input image prior to denoising. The pre-processing can include, but is not limited to, adjusting the noise level of an acquired image or applying enhancements to an acquired image that is used as a conditional image. In one example, partial information from an acquired image can be added to a restored output image as a post-processing step. In one embodiment, a piecewise function having different noise terms can be integrated into DDPMs regardless of the training process. For example, different models can be trained using different loss functions and/or training sets. In one embodiment, the DDPM can be a parameter-encoded model, wherein the model can receive parameters as inputs in order to guide the diffusion process. In one example, a parameter can correspond to an image property.

The systems and methods described herein are compatible with other methods for reducing the processing time of a diffusion-based image denoising model. Such methods can include, but are not limited to, using a denoising diffusion implicit model; reducing the number of diffusion steps T; implementing an early stop to the diffusion process; using a fast ordinary differential equation solver; pre-segmentation diffusion sampling; and using a high-frequency space diffusion model.

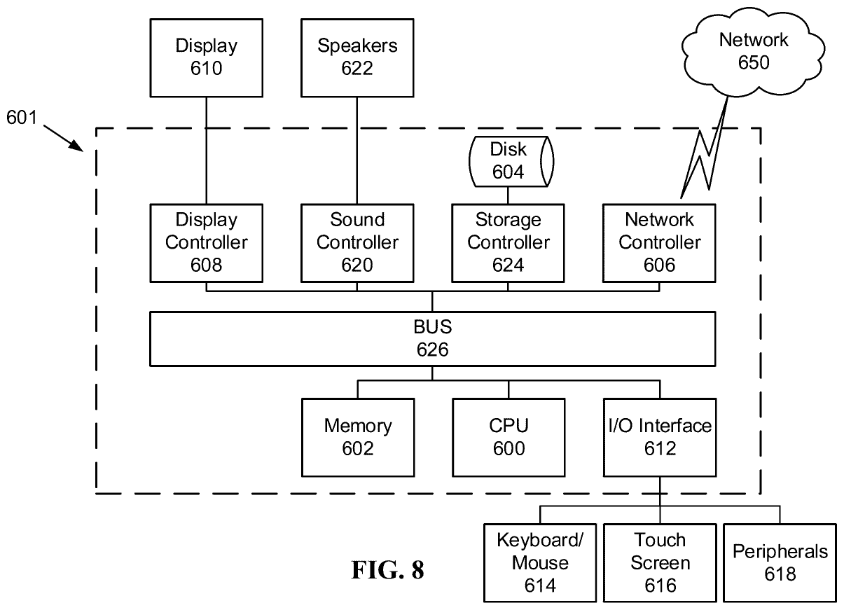

Next, a hardware description of a device 601 according to exemplary embodiments is described with reference to FIG. 8. In FIG. 8 the device 601 includes processing circuitry. The device 601 can be used to execute any of the methods described herein related to obtaining the DDPM, training the DDPM, receiving acquired images, and/or denoising an image using the DDPM. In one embodiment, the device 601 can be a server, a computer, etc. In one embodiment, the device 601 can be in communication with or embedded in an image acquisition device, such as the CT device illustrated in FIG. 8. In one embodiment, the methods described herein can be distributed across one or more devices, the one or more devices including at least some of the elements of device 601. The processing circuitry includes one or more of the elements discussed next with reference to FIG. 8. The process data and instructions may be stored in memory 602. These processes and instructions may also be stored on a storage medium disk 604 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device 601 communicates, such as a server or computer.

Further, the claimed advancements may be provided as a utility application, background daemon, or component of an operating system, or combination thereof, executing in conjunction with CPU 600 and an operating system such as Microsoft Windows, UNIX, Solaris, LINUX, Apple MAC-OS and other systems known to those skilled in the art.

The hardware elements in order to achieve the device 601 may be realized by various circuitry elements, known to those skilled in the art. For example, CPU 600 may be a Xenon or Core processor from Intel of America or an Opteron processor from AMD of America, or may be other processor types that would be recognized by one of ordinary skill in the art. Alternatively, the CPU 600 may be implemented on an FPGA, ASIC, PLD or using discrete logic circuits, as one of ordinary skill in the art would recognize. Further, CPU 600 may be implemented as multiple processors cooperatively working in parallel to perform the instructions of the processes described above.

The device 601 in FIG. 8 also includes a network controller 606, such as an Intel Ethernet PRO network interface card from Intel Corporation of America, for interfacing with network 650. and to communicate with the other devices. As can be appreciated, the network 650 can be a public network, such as the Internet, or a private network such as an LAN or WAN network, or any combination thereof and can also include PSTN or ISDN sub-networks. The network 650 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The device 601 further includes a display controller 608, such as a NVIDIA GeForce GTX or Quadro graphics adaptor from NVIDIA Corporation of America for interfacing with display 610, such as an LCD monitor. A general purpose I/O interface 612 interfaces with a keyboard and/or mouse 614 as well as a touch screen panel 616 on or separate from display 610. General purpose I/O interface also connects to a variety of peripherals 618 including printers and scanners.

A sound controller 620 is also provided in the device 601 to interface with speakers/microphone 622 thereby providing sounds and/or music.

The general purpose storage controller 624 connects the storage medium disk 604 with communication bus 626, which may be an ISA, EISA, VESA, PCI, or similar, for interconnecting all of the components of the device 601. A description of the general features and functionality of the display 610, keyboard and/or mouse 614, as well as the display controller 608, storage controller 624, network controller 606, sound controller 620, and general purpose I/O interface 612 is omitted herein for brevity as these features are known.

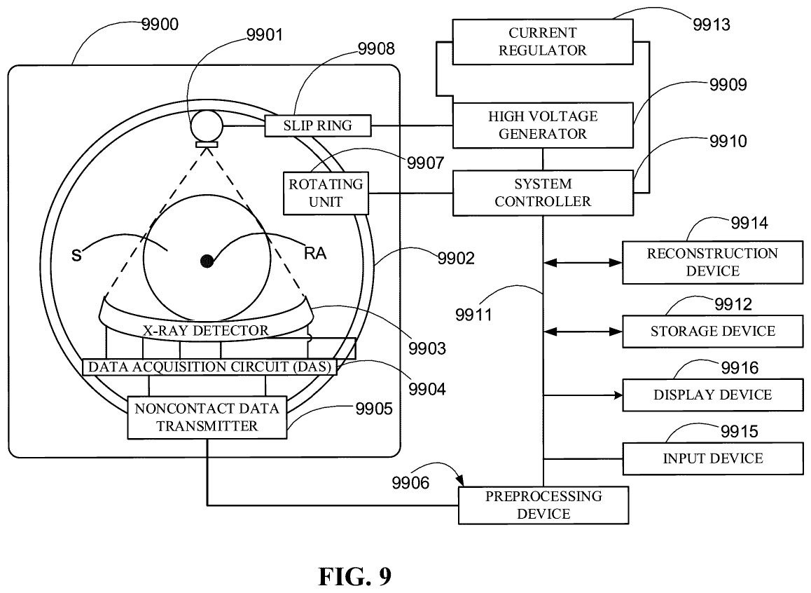

In one embodiment, the images processed using the bulk diffusion methods described herein can be CT images acquired by a CT apparatus or scanner. FIG. 9 illustrates an implementation of a radiography gantry included in a CT apparatus or scanner. As shown in FIG. 9, a radiography gantry 9900 is illustrated from a side view and further includes an X-ray tube 9901, an annular frame 9902, and a multi-row or two-dimensional-array-type X-ray detector 9903. The X-ray tube 9901 and X-ray detector 9903 are diametrically mounted across an object, such as, for example, a patient, on the annular frame 9902, which is rotatably supported around a rotation axis RA. A rotating unit 9907 rotates the annular frame 9902 at a high speed, such as, for example, 0.4 sec/rotation, while the object is being moved along the axis RA into or out of the illustrated page.

An embodiment of an X-ray computed tomography (CT) apparatus according to the present disclosure will be described below with reference to the views of the accompanying drawing. Note that X-ray CT apparatuses include various types of apparatuses, e.g., a rotate/rotate-type apparatus in which an X-ray tube and X-ray detector rotate together around an object to be examined, and a stationary/rotate-type apparatus in which many detection elements are arrayed in the form of a ring or plane, and only an X-ray tube rotates around an object to be examined. The present disclosure can be applied to either type. In this case, the rotate/rotate type, which is currently the mainstream, will be exemplified.

The multi-slice X-ray CT apparatus further includes a high voltage generator 9909 that generates a tube voltage applied to the X-ray tube 9901 through a slip ring 9908 such that the X-ray tube 9901 generates X-rays. An X-ray detector 9903 is located at an opposite side from the X-ray tube 9901 across the object for detecting the emitted X-rays that have transmitted through the object. The X-ray detector 9903 is for example a photon-counting detector. The X-ray detector, or the photon-counting detector 9903 further includes individual detector elements or units, such as, for example, processing circuitry.

The CT apparatus further includes other devices for processing the detected signals from X-ray detector 9903. A data acquisition circuit or a Data Acquisition System (DAS) 9904 converts a signal output from the X-ray detector 9903 for each channel into a voltage signal, amplifies the signal, and further converts the signal into a digital signal. The X-ray detector 9903 and the DAS 9904 are configured to manage a predetermined total number of projections per rotation (TPPR).

The above-described data is sent to a preprocessing device 9906, which is housed in a console outside the radiography gantry 9900 through a non-contact data transmitter 9905. The preprocessing device 9906 performs certain corrections. A memory 9912 stores the resultant data, which is also called projection data at a stage immediately before reconstruction processing. The memory 9912 is connected to a system controller 9910 through a data/control bus 9911, together with a reconstruction device 9914, input device 9915, and display 9916. The system controller 9910 controls a current regulator 9913 that limits the current to a level sufficient for driving the CT system.

The detectors are rotated and/or fixed with respect to the object being scanned, such as the patient, among various generations of the CT scanner systems. In one implementation, the above-described CT system can be an example of a combined third-generation geometry and fourth-generation geometry system. In the third-generation system, the X-ray tube 9901 and the X-ray detector 9903 are diametrically mounted on the annular frame 9902 and are rotated around the object as the annular frame 9902 is rotated about the rotation axis RA. In the fourth-generation geometry system, the detectors are fixedly placed around the patient and an X-ray tube 9901 rotates around the patient. In an alternative embodiment, the radiography gantry 9900 has multiple detectors arranged on the annular frame 9902, which is supported by a C-arm and a stand.

Post-reconstruction processing performed by the reconstruction device 9914 can include filtering and smoothing the image, volume rendering processing, and image difference processing as needed. The image reconstruction process can implement various CT image reconstruction methods. The reconstruction device 9914 can use the memory to store, e.g., projection data, reconstructed images, calibration data and parameters, and computer programs.

While this specification contains many specific implementation details, these should not be construed as limitations on the scope of what may be claimed, but rather as descriptions of features that may be specific to particular embodiments.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Embodiments of the present disclosure may also be set forth in the following parentheticals.

(1) A method of denoising an input image, the method comprising: obtaining a diffusion-based probabilistic model that was trained, using at least one target image and at least one conditional image, to perform denoising over a number of denoising steps; performing, using the obtained model and a first seed image, a first sequence of T1 denoising sampling steps based on the input image to generate a first output image that is a first restored image corresponding to the input image, wherein each denoising sampling step of the first sequence of T1 denoising sampling steps includes generating the first seed image according to a first seed image function; and performing, using the obtained model and a second seed image, a second sequence of T2 denoising sampling steps based on an intermediate image generated as a result of the first sequence of T1 denoising sampling steps to generate a second output image that is a second restored image corresponding to the input image, wherein each denoising sampling step of the second sequence of T2 denoising sampling steps includes generating a second seed image according to a second seed image function.

(2) The method of (1), wherein the second seed image function is based on a desired image property of the second output image.

(3) The method of (1) to (2), wherein the desired image property is a desired image resolution.

(4) The method of (1) to (3), wherein the desired image property is a desired image noise level.

(5) The method of (1) to (4), wherein the second seed image function includes applying a scalar multiplier to a unit Gaussian noise image.

(6) The method of (1) to (5), wherein the second seed image function includes applying a low-pass filter to a unit Gaussian noise image.

(7) The method of (1) to (6), wherein a value of T2 is set based on a desired image property of the second output image.

(8) A non-transitory computer-readable storage medium for storing computer readable instructions that, when executed by a computer, cause the computer to perform a method, the method comprising: obtaining a diffusion-based probabilistic model that was trained, using at least one target image and at least one conditional image, to perform denoising over a number of denoising steps; performing, using the obtained model and a first seed image, a first sequence of T1 denoising sampling steps based on the input image to generate a first output image that is a first restored image corresponding to the input image, wherein each denoising sampling step of the first sequence of T1 denoising sampling steps includes generating the first seed image according to a first seed image function; and performing, using the obtained model and a second seed image, a second sequence of T2 denoising sampling steps based on an intermediate image generated as a result of the first sequence of T1 denoising sampling steps to generate a second output image that is a second restored image corresponding to the input image, wherein each denoising sampling step of the second sequence of T2 denoising sampling steps includes generating a second seed image according to a second seed image function.

(9) The non-transitory computer-readable storage medium of (8), wherein the second seed image function is based on a desired image property of the second output image.

(10) The non-transitory computer-readable storage medium of (8) to (9), wherein the desired image property is a desired image resolution.

(11) The non-transitory computer-readable storage medium of (8) to (10), wherein the desired image property is a desired image noise level.

(12) The non-transitory computer-readable storage medium of (8) to (11), wherein the second seed image function includes applying a scalar multiplier to a unit Gaussian noise image.

(13) The non-transitory computer-readable storage medium of (8) to (12), wherein the second seed image function includes applying a low-pass filter to a unit Gaussian noise image.

(14) The non-transitory computer-readable storage medium of (8) to (13), wherein a value of T2 is set based on a desired image property of the second output image.

(15) An apparatus, comprising: processing circuitry configured to obtain a diffusion-based probabilistic model that was trained, using at least one target image and at least one conditional image, to perform denoising over a number of denoising steps; perform, using the obtained model and a first seed image, a first sequence of T1 denoising sampling steps based on the input image to generate a first output image that is a first restored image corresponding to the input image, wherein each denoising sampling step of the first sequence of T1 denoising sampling steps includes generating the first seed image according to a first seed image function; and perform, using the obtained model and a second seed image, a second sequence of T2 denoising sampling steps based on an intermediate image generated as a result of the first sequence of T1 denoising sampling steps to generate a second output image that is a second restored image corresponding to the input image, wherein each denoising sampling step of the second sequence of T2 denoising sampling steps includes generating a second seed image according to a second seed image function.

(16) The apparatus of (15), wherein the second seed image function is based on a desired image property of the second output image.

(17) The apparatus of (15) to (16), wherein the desired image property is a desired image resolution.

(18) The apparatus of (15) to (17), wherein the desired image property is a desired image noise level.

(19) The apparatus of (15) to (18), wherein the second seed image function includes applying a multiplier to a unit Gaussian noise image.

(20) The apparatus of (15) to (19), wherein the second seed image function includes applying a low-pass filter to a unit Gaussian noise image.

Obviously, numerous modifications and variations are possible in light of the above teachings. It is therefore to be understood that within the scope of the appended claims, embodiment of the present disclosure may be practiced otherwise than as specifically described herein.

1. A method of denoising an input image, the method comprising:
obtaining a diffusion-based probabilistic model that was trained, using at least one target image and at least one conditional image, to perform denoising over a number of denoising steps;
performing, using the obtained model and a first seed image, a first sequence of T1 denoising sampling steps based on the input image to generate a first output image that is a first restored image corresponding to the input image, wherein each denoising sampling step of the first sequence of T1 denoising sampling steps includes generating the first seed image according to a first seed image function; and
performing, using the obtained model and a second seed image, a second sequence of T2 denoising sampling steps based on an intermediate image generated as a result of the first sequence of T1 denoising sampling steps to generate a second output image that is a second restored image corresponding to the input image, wherein each denoising sampling step of the second sequence of T2 denoising sampling steps includes generating a second seed image according to a second seed image function.

2. The method of claim 1, wherein the second seed image function is based on a desired image property of the second output image.

3. The method of claim 2, wherein the desired image property is a desired image resolution.

4. The method of claim 2, wherein the desired image property is a desired image noise level.

5. The method of claim 1, wherein the second seed image function includes applying a scalar multiplier to a unit Gaussian noise image.

6. The method of claim 1, wherein the second seed image function includes applying a low-pass filter to a unit Gaussian noise image.

7. The method of claim 1, wherein a value of T2 is set based on a desired image property of the second output image.

8. A non-transitory computer-readable storage medium for storing computer readable instructions that, when executed by a computer, cause the computer to perform a method, the method comprising:
obtaining a diffusion-based probabilistic model that was trained, using at least one target image and at least one conditional image, to perform denoising over a number of denoising steps;
performing, using the obtained model and a first seed image, a first sequence of T1 denoising sampling steps based on the input image to generate a first output image that is a first restored image corresponding to the input image, wherein each denoising sampling step of the first sequence of T1 denoising sampling steps includes generating the first seed image according to a first seed image function; and
performing, using the obtained model and a second seed image, a second sequence of T2 denoising sampling steps based on an intermediate image generated as a result of the first sequence of T1 denoising sampling steps to generate a second output image that is a second restored image corresponding to the input image, wherein each denoising sampling step of the second sequence of T2 denoising sampling steps includes generating a second seed image according to a second seed image function.

9. The non-transitory computer-readable storage medium of claim 8, wherein the second seed image function is based on a desired image property of the second output image.

10. The non-transitory computer-readable storage medium of claim 9, wherein the desired image property is a desired image resolution.

11. The non-transitory computer-readable storage medium of claim 9, wherein the desired image property is a desired image noise level.

12. The non-transitory computer-readable storage medium of claim 8, wherein the second seed image function includes applying a scalar multiplier to a unit Gaussian noise image.

13. The non-transitory computer-readable storage medium of claim 8, wherein the second seed image function includes applying a low-pass filter to a unit Gaussian noise image.

14. The non-transitory computer-readable storage medium of claim 8, wherein a value of T2 is set based on a desired image property of the second output image.

15. An apparatus, comprising:
processing circuitry configured to
obtain a diffusion-based probabilistic model that was trained, using at least one target image and at least one conditional image, to perform denoising over a number of denoising steps;
perform, using the obtained model and a first seed image, a first sequence of T1 denoising sampling steps based on the input image to generate a first output image that is a first restored image corresponding to the input image, wherein each denoising sampling step of the first sequence of T1 denoising sampling steps includes generating the first seed image according to a first seed image function; and
perform, using the obtained model and a second seed image, a second sequence of T2 denoising sampling steps based on an intermediate image generated as a result of the first sequence of T1 denoising sampling steps to generate a second output image that is a second restored image corresponding to the input image, wherein each denoising sampling step of the second sequence of T2 denoising sampling steps includes generating a second seed image according to a second seed image function.

16. The apparatus of claim 15, wherein the second seed image function is based on a desired image property of the second output image.

17. The apparatus of claim 16, wherein the desired image property is a desired image resolution.

18. The apparatus of claim 16, wherein the desired image property is a desired image noise level.

19. The apparatus of claim 15, wherein the second seed image function includes applying a multiplier to a unit Gaussian noise image.

20. The apparatus of claim 15, wherein the second seed image function includes applying a low-pass filter to a unit Gaussian noise image.
